(19) United States
(12) Patent Application Publication
(10) Pub. No.: US 2026/0080635 A1
(43) Pub. Date: Mar. 19, 2026

(54) AUGMENTED REALITY COLLABORATION SYSTEM AND COLLABORATION METHOD THEREOF

(71) Applicants: Inventec (Pudong) Technology Corporation, Shanghai (CN); INVENTEC CORPORATION, TAIPEI CITY (TW)

(72) Inventors: Chih-Yuan YAO, TAIPEI CITY (TW); Chien-Hua CHEN, TAIPEI CITY (TW); Chu-Li HUANG, TAIPEI CITY (TW); You-Chun HSIEH, TAIPEI CITY (TW); Wei-Chao CHEN, TAIPEI CITY (TW); Chih-Pin WEI, TAIPEI CITY (TW)

(21) Appl. No.: 19/238,545

(22) Filed: Jun. 16, 2025

(30) Foreign Application Priority Data
Sep. 18, 2024 (CN) 202411304854.9

(51) Int. Cl. G06T 19/00; G06T 17/00

(52) U.S. Cl. CPC G06T 19/006; G06T 17/00; G06T 2219/024

(57) ABSTRACT

An augmented reality collaboration system includes an assembly platform, a first projector, a camera and a computing circuit. The first projector projects a first projection image to the assembly platform. The camera shoots the assembly platform and the first projection image projected on the assembly platform to obtain a first shooting image. The computing circuit creates a three-dimensional model in a virtual three-dimensional space, arranges a standard operating procedure, sets a mark pattern on the three-dimensional model according to the standard operating procedure, analyzes the first shooting picture, and performs a calibration operation on the first projector to obtain a first calibration parameter. The computing circuit enables the first projector to generate a first corrected pattern according to the first calibration parameter and the mark pattern, and projects the first corrected pattern to the object-to-be-assembled according to the standard operating procedure.

### CROSS-REFERENCE TO RELATED APPLICATION

This application claims priority to China Application Serial Number 202411304854.9, filed Sep. 18, 2024, which is herein incorporated by reference in its entirety.

### BACKGROUND

### Field of the Invention

This disclosure relates to an augmented reality collaboration system and a collaboration method thereof, and in particular to the augmented reality collaboration system and the collaboration method thereof applied in a hardware assembly process.

### Description of Related Art

Regarding the conventional object assembly process, technicians on the production line can only start assembling hardware parts according to the established work flow in a real environment. However, the technicians on the production line often encounter trouble when assembling objects due to lack of clear guidance.

How to create a collaborative system that allows the technicians on the production line to receive clear guidance when assembling objects to avoid errors during assembling is an important issue that the people having ordinary skills in this field have to deal with.

### SUMMARY

The present disclosure provides an augmented reality collaboration system. The augmented reality collaboration system comprises an assembly platform, a first projector, a camera and a computing circuit. The assembly platform is configured to place an object-to-be-assembled. The first projector is configured to project a first projection image onto the assembly platform. The camera is configured to shoot the assembly platform and the first projection image projected on the assembly platform to obtain a first shooting image. The computing circuit is coupled to the first projector and the camera. The computing circuit is configured for executing an editor for creating a three-dimensional model in a virtual three-dimensional space, arranging a standard operating procedure, and setting a mark pattern on the three-dimensional model according to the standard operating procedure; analyzing the first shooting image, performing a calibration operation on the first projector to obtain a first calibration parameter. The computing circuit is configured for enabling the first projector to generate a first corrected pattern according to the first calibration parameter and the mark pattern, and projecting the first corrected pattern onto the object-to-be-assembled according to the standard operating procedure.

In some embodiments, the augmented reality collaboration system performs a keystone calibration on the first projector during the calibration operation.

In some embodiments, the augmented reality collaboration system performs at least one of a rotation calibration and a height calibration on the first projector during the calibration operation.

In some embodiments, a plurality of virtual coordinates in the virtual three-dimensional space is corresponded to a plurality of physical coordinates on the assembly platform, the three-dimensional model is corresponded to the object-to-be-assembled.

In some embodiments, the camera is disposed directly above the assembly platform.

In some embodiments, the augmented reality collaboration system further comprises a second projector. The second projector is configured to project a second projection image onto the assembly platform. The camera shoots the assembly platform and the second projection image projected on the assembly platform to obtain a second shooting image. The computing circuit analyzes the second shooting image and performs the calibration operation on the second projector to obtain a second calibration parameter. The second projector generates a second corrected pattern according to the second calibration parameter and the mark pattern, and projects the second corrected pattern onto the object-to-be-assembled according to the standard operating procedure.

The present disclosure provides an augmented reality collaboration method. The method comprises: placing an object-to-be-assembled on an assembly platform; projecting a first projection image onto the assembly platform by a first projector; shooting the assembly platform and the first projection image projected on the assembly platform to obtain a first shooting image by a camera; executing an editor for creating a three-dimensional model in a virtual three-dimensional space, arranging a standard operating procedure, and setting a mark pattern on the three-dimensional model according to the standard operating procedure; analyzing the first shooting image, performing a calibration operation on the first projector to obtain a first calibration parameter; and enabling the first projector to generate a first corrected pattern according to the first calibration parameter and the mark pattern, and projecting the first corrected pattern onto the object-to-be-assembled according to the standard operating procedure.

In some embodiments, the augmented reality collaboration method performs a keystone calibration on the first projector during the calibration operation.

In some embodiments, the augmented reality collaboration method performs at least one of a rotation calibration and a height calibration on the first projector during the calibration operation.

In some embodiments, a plurality of virtual coordinates in the virtual three-dimensional space is corresponded to a plurality of physical coordinates on the assembly platform, the three-dimensional model is corresponded to the object-to-be-assembled.

In some embodiments, the camera is disposed directly above the assembly platform.

In some embodiments, the augmented reality collaboration method projecting a second projection image onto the assembly platform by a second projector; shooting the assembly platform and the second projection image projected on the assembly platform to obtain a second shooting image; analyzing the second shooting image, performing the calibration operation on the second projector to obtain a second calibration parameter; and generating a second corrected pattern according to the second calibration parameter and the mark pattern, and projecting the second corrected pattern onto the object-to-be-assembled according to the standard operating procedure.

In the augmented reality collaboration system of present disclosure, the first corrected pattern can not only display the mark pattern of the three-dimensional model at the corresponding position on the object-to-be-assembled, but also does not cause distortion, skewness or rotation angle deviation when the first corrected pattern is projected onto the object-to-be-assembled. During the standard operating procedure of object assembly, the augmented reality collaboration system of present disclosure can provide clear instructions to the technicians on the production line by projecting the first corrected pattern.

### BRIEF DESCRIPTION OF THE DRAWINGS

FIG. 1 is a schematic diagram of an augmented reality collaboration system according to an embodiment of the present disclosure.

FIG. 2 is a schematic diagram of an editing interface of an augmented reality editor according to an embodiment of the present disclosure.

FIG. 3A is a schematic diagram of a keystone calibration of the augmented reality collaboration system according to an embodiment of the present disclosure.

FIG. 3B is a schematic diagram of the keystone calibration of the augmented reality collaboration system according to an embodiment of the present disclosure.

FIG. 4A is a schematic diagram of a rotation calibration of the augmented reality collaboration system according to an embodiment of the present disclosure.

FIG. 4B is a schematic diagram of the rotation calibration of the augmented reality collaboration system according to an embodiment of the present disclosure.

FIG. 5 is a schematic diagram of a height calibration of the augmented reality collaboration system according to an embodiment of the present disclosure.

FIG. 6 is a schematic diagram of a center point calibration of the augmented reality collaboration system according to an embodiment of the present disclosure.

FIG. 7 is a flow chart of an augmented reality collaboration method according to an embodiment of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

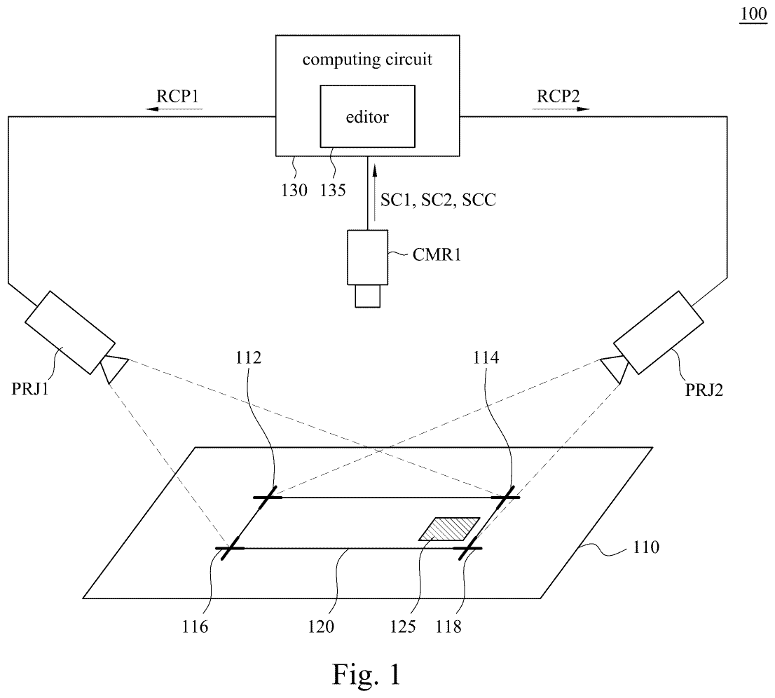

Referring to FIG. 1, FIG. 1 is a schematic diagram of an augmented reality collaboration system 100 according to an embodiment of the present disclosure. The augmented reality collaboration system 100 comprises an assembly platform 110, a computing circuit 130, a camera CMR1, a projector PRJ1 and a projector PRJ2.

The assembly platform 110 is configured to place an object-to-be-assembled 120. The assembly platform 110 may comprise physical coordinates 112, 114, 116, 118, which may be configured to mark the placement location of the object-to-be-assembled 120 on the assembly platform 110. The object-to-be-assembled 120 may be a chassis to be assembled, a circuit board, a server, an industrial computer, a car computer, an Internet of Things device, or other devices that need to be assembled. The amount of physical coordinates can be adjusted according to different implementations and is not limited to four.

In an embodiment, the augmented reality collaboration system 100 may be applied to an assembly production line in a factory to guide the technicians to assemble the object-to-be-assembled 120 quickly and correctly. For example, the augmented reality collaboration system 100 can instruct the technicians to insert multiple components into correct slots in sequence or to lock screws into correct screw holes. In the production line operations, since the technicians have their own working habits, even if a set of production processes is established, the technicians may still install the components out of sequence or install the components into the wrong position. In an embodiment of the present disclosure, the augmented reality collaboration system 100 may arrange a set of standard operating procedures (SOP), and based on the set of procedures, project an appropriate mark pattern on the object-to-be-assembled 120 as an assembly guide. The technicians on the production line may know the current position of the object-to-be-assembled 120 that needs to be assembled and the subsequent assembly sequence according to the instructions of the mark pattern.

The computing circuit 130 may be equipped with an operating system. Furthermore, the computing circuit 130 may control the camera CMR1, the projector PRJ1, and the projector PRJ2 through a physical line connection or a wireless connection.

The computing circuit 130, the camera CMR1, the projector PRJ1 and the projector PRJ2 may be implemented as four independent devices. Alternatively, the computing circuit 130, the camera CMR1, the projector PRJ1 and the projector PRJ2 may be integrated into the same device, the present disclosure is not limited thereto.

In some embodiments, the projector PRJ1 may be disposed on one side obliquely above the assembly platform 110 to project a first projection image onto the assembly platform 110. The camera CMR1 may be disposed directly above the assembly platform 110 to shoot the assembly platform 110 and a first projection image projected onto the assembly platform 110 by the projector PRJ1 to obtain a shooting image SC1.

In some embodiments, the projector PRJ2 may be disposed on the other side of assembly platform 110 obliquely above and opposite to the location where the projector PRJ1 is disposed. The projector PRJ2 may project a second projection image onto the assembly platform 110. The camera CMR1 may shoot the assembly platform 110 and the second projection image projected onto assembly platform 110 by the projector PRJ2 to obtain a shooting image SC2.

In some embodiments, the projector PRJ1 and the projector PRJ2 may simultaneously project their respective projection images onto the assembly platform 110. In one of the embodiments, the first projection image of the projector PRJ1 does not overlap the second projection image of the projector PRJ2; in another embodiment, the first projection image of the projector PRJ1 may partially overlap the second projection image of the projector PRJ2; in another embodiment, the first projection image of the projector PRJ1 completely overlaps the second projection image of the projector PRJ2. In these embodiments, the camera CMR1 may shoot the assembly platform 110 and the projection images projected onto the assembly platform 110 by each projector to obtain a shooting image SCC.

The computing circuit 130 may receive one of the shooting image SC1, the shooting image SC2 and the shooting image SCC, and the computing circuit 130 may perform a calibration operation on at least one of the projector PRJ1 and the projector PRJ2 to obtain at least one of a calibration parameter RCP1 corresponding to the projector PRJ1 and the calibration parameter RCP2 corresponding to the projector PRJ2. For example, after receiving the shooting image SC1, the computing circuit 130 may calculate whether the first projection image of the projector PRJ1 has distortion, skewness or rotation angle offset through the calibration operation, so that the computing circuit 130 may determine whether the projector PRJ1 needs to be adjusted, and the computing circuit 130 may calculate the calibration parameter RCP1. The computing circuit 130 may also calibrate the projector PRJ2 through the calibration operation and calculate the calibration parameter RCP2.

The calibration operation mentioned above may include at least one of a keystone calibration, a rotation calibration and a height calibration. The specific implementation methods of the keystone calibration, the rotation calibration and the height calibration in the calibration operation will be explained below.

The computing circuit 130 may execute the editor 135. The editor 135 may be an augmented reality editor. The editor 135 may create a three-dimensional model in a virtual three-dimensional space and arrange the standard operating procedure. The three-dimensional model produced by the editor 135 may correspond to the object-to-be-assembled 120 placed on the assembly platform 110. For example, the three-dimensional model of this embodiment may be a three-dimensional model of the circuit board represented as the object-to-be-assembled 120 in a virtual space. The standard operating procedure can be any assembly process for assembling electronic devices or any assembly process for assembling any similar objects.

The editor 135 may set the mark pattern on the three-dimensional model according to the standard operating procedure described above. The computing circuit 130 may generate a first corrected pattern according to the calibration parameter RCP1 and the mark pattern on the three-dimensional model. The first corrected pattern has a set of physical three-dimensional coordinates. The first corrected pattern may be sent to the projector PRJ1. The computing circuit 130 may generate a second corrected pattern according to the calibration parameter RCP2 and the mark pattern on the three-dimensional model. The second corrected pattern has a set of physical three-dimensional coordinates. The second corrected pattern can be sent to the projector PRJ2.

The computing circuit 130 may enable the projector PRJ1 to project the first corrected pattern onto the object-to-be-assembled 120 and enable the projector PRJ2 to project the second corrected pattern onto the object-to-be-assembled 120 according to the standard operating procedure.

In an embodiment, the first corrected pattern and the second corrected pattern may have two different sets of physical three-dimensional coordinates. In this embodiment, the first corrected pattern may be the corrected pattern 125, and the second corrected pattern may be another corrected pattern not shown in FIG. 1. There may be two corrected patterns displayed on the object-to-be-assembled 120 at the same time.

In another embodiment, the first corrected pattern and the second corrected pattern have the same physical three-dimensional coordinates. In this embodiment, the first corrected pattern and the second corrected pattern may overlap to form a corrected pattern 125, and a corrected pattern may be displayed on the object-to-be-assembled 120. The corrected pattern in this embodiment may be clearer and has a higher brightness.

In summary, in the augmented reality collaboration system 100, since the corrected pattern 125 has the calibration parameter obtained by the calibration operation, the corrected pattern 125 and the second corrected pattern can display the mark pattern on the three-dimensional model at the corresponding position of the object-to-be-assembled 120, and also, when the corrected pattern 125 is projected onto the object-to-be-assembled 120, there will be no distortion, skewness or rotation angle deviation. Therefore, during the standard operating procedure of object assembly, the augmented reality collaboration system 100 can provide clear instructions to the technicians on the production line by projecting the corrected pattern 125.

It is worth mentioning that in some embodiments, after the technicians follows the instructions of the corrected pattern 125 to install a specified component to the corresponding position of the object-to-be-assembled 120, the computing circuit 130 can determine whether the specific step of the standard operation flow is completed through the shooting image obtained by the camera CMR1, and the computing circuit 130 can further determine whether the next step of the standard operation flow can be executed.

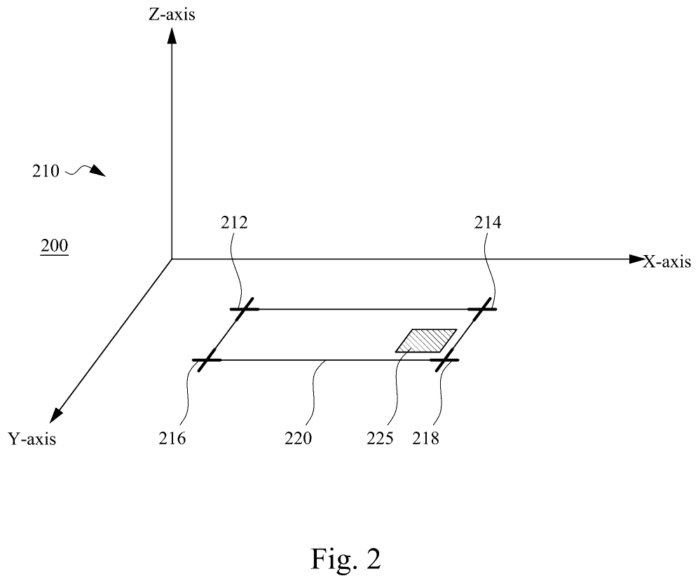

Refer to FIG. 2, FIG. 2 is a schematic diagram of an editing interface of an augmented reality editor 200 according to an embodiment of the present disclosure. The augmented reality editor 200 may correspond to the editor 135 in FIG. 1.

The augmented reality editor 200 sets a virtual three-dimensional space 210. The virtual three-dimensional space 210 has an X-axis, a Y-axis, and a Z-axis. In this embodiment, the three-dimensional model 220 may be disposed on the planes of the X-axis and the Y-axis. Virtual coordinates 212, 214, 216, and 218 are disposed around the three-dimensional model 220. These virtual coordinates can mark the position of the three-dimensional model 220 in the virtual three-dimensional space 210. As described in the embodiment of FIG. 1, the three-dimensional model 220 may be a three-dimensional model of the circuit board represented as the object-to-be-assembled 120 in the virtual space. The virtual coordinate 212, 214, 216, 218 may correspond to the physical coordinates 112, 114, 116, 118.

At least one mark pattern, such as mark pattern 225, may be disposed on the three-dimensional model 220. In this embodiment, the mark pattern 225 has a virtual three-dimensional coordinate. The portion of the three-dimensional model 220 marked by the mark pattern 225 may correspond to the three-dimensional element in the object-to-be-assembled 120, such as a slot, an interface, a connection port, or a similar structure that can be imagined by a person having ordinary skills in the art.

It is worth mentioning that the amount of virtual coordinates can be adjusted according to different implementations and is not limited to four. The placement position of the three-dimensional model 220 is not limited to the planes of the X-axis and the Y-axis.

When performing the standard operating procedure of object assembly, the augmented reality collaboration system 100 can access the three-dimensional model 220 and the mark pattern 225 from the augmented reality editor 200. Furthermore, the augmented reality collaboration system 100 can sense the physical coordinates of the assembly platform 110 through the camera CMR1, and then perform a coordinate conversion operation through the virtual coordinates of the virtual three-dimensional space 210, the mark pattern 225, and the calibration parameter of the projector, so that the augmented reality collaboration system 100 can convert the virtual three-dimensional coordinates of the mark pattern 225 into the physical three-dimensional coordinates of the corrected pattern 125, and then project the corrected pattern 125 onto the object-to-be-assembled 120.

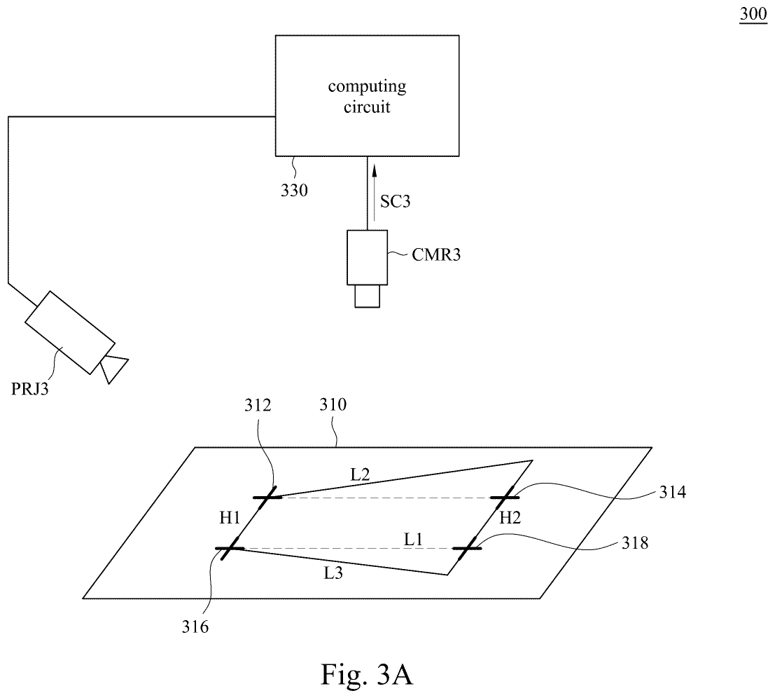

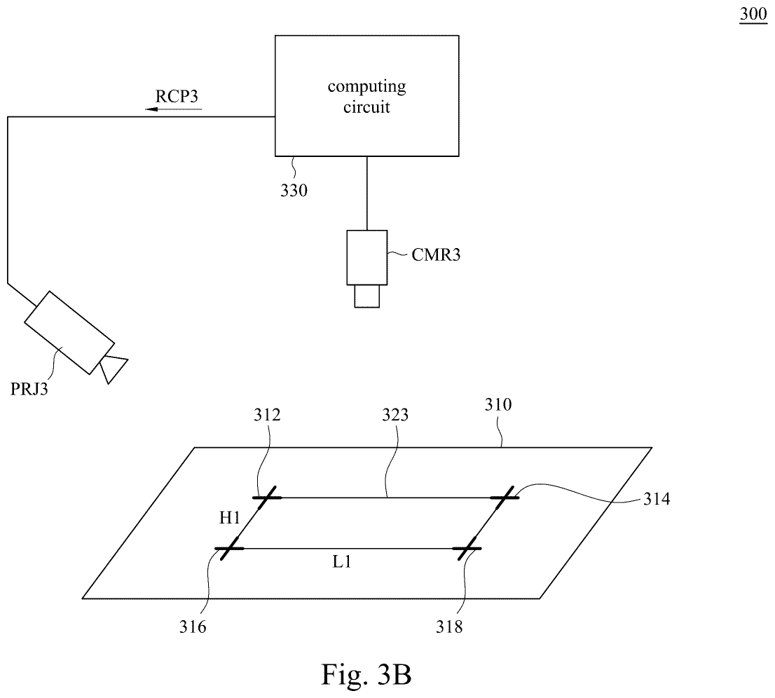

Referring to FIGS. 3A and 3B, FIGS. 3A and 3B are both schematic diagrams of keystone calibration of the augmented reality collaboration system 300 according to an embodiment of the present disclosure. The augmented reality collaboration system 300 may correspond to the augmented reality collaboration system 100 of FIG. 1. The projector PRJ3 may correspond to any one of the projectors PRJ1 and PRJ2 in FIG. 1.

In FIG. 3A, a platform 310 has physical coordinates 312, 314, 316, and 318. The physical coordinates 312, 314, 316, 318 can be configured as four corners of a rectangle. Length of a line connecting the physical coordinate 312 and the physical coordinate 314 is a length L1, and length of a line connecting the physical coordinate 312 and the physical coordinate 316 is a length H1.

A computing circuit 330 controls the projector PRJ3 so that the projector PRJ3 aligns a projection image 322 with the physical coordinate 312 and the physical coordinate 316. According to the coordinate conversion operation of the computing circuit 330, the projection image 322 should be a rectangle, and the four corners of the projection image 322 should be aligned with the physical coordinates 312, 314, 316, and 318. However, the projection image 322 is a trapezoid, with a top length of length H1, a bottom length of length H2 greater than length H1, and side lengths of lengths L2 and L3 greater than length L1. The corners of projection image 322 do not overlap with the physical coordinates 314, 318.

The computing circuit 330 shoots the platform 310 and the projection image 322 projected on the platform 310 by the camera CMR3 to obtain a shooting image SC3. Through the shooting image SC3, the computing circuit 330 can calculate a trapezoidal calibration parameter RCP3.

In FIG. 3B, the computing circuit 330 calibrates the projection image 322 according to the trapezoidal calibration parameter RCP3 to generate a projection image 323. The camera CMR3 projects the projection image 323 onto the platform 310. Four corners of the projection image 323 are aligned with the physical coordinates 312, 314, 316, 318. That is, in FIG. 3B, the augmented reality collaboration system 300 has completed the keystone calibration. The augmented reality collaboration system 100 of FIG. 1 may also perform the keystone calibration with reference to FIGS. 3A and 3B.

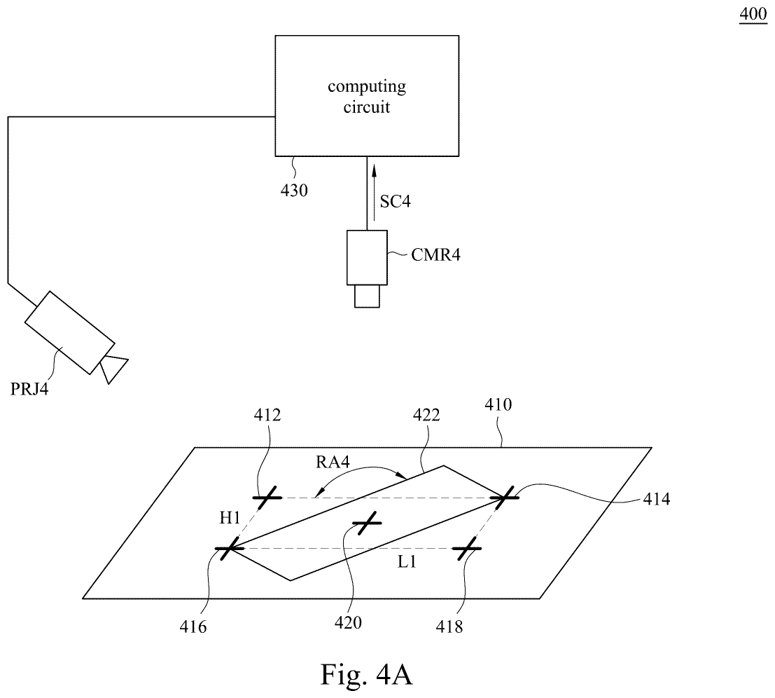

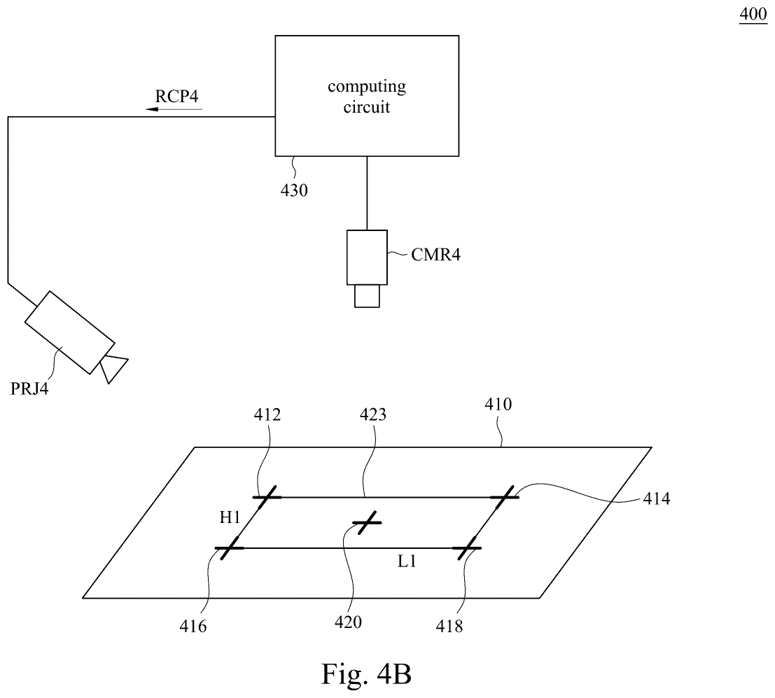

Referring to FIGS. 4A and 4B, FIGS. 4A and 4B are both schematic diagrams of rotation calibration of the augmented reality collaboration system 400 according to an embodiment of the present disclosure. The augmented reality collaboration system 400 may correspond to the augmented reality collaboration system 100 of FIG. 1. A projector PRJ4 may correspond to any one of the projectors PRJ1 and PRJ2 in FIG. 1.

In FIG. 4A, a platform 410 has physical coordinates 412, 414, 416, 418, and 420. The physical coordinates 412, 414, 416, 418 may be configured as four corners of a rectangle, and the physical coordinate 420 may be configured as center of the rectangle. Length of a line connecting the physical coordinate 412 and the physical coordinate 414 is the length L1, and length of a line connecting the physical coordinate 412 and the physical coordinate 416 is the length H1.

A computing circuit 430 controls the projector PRJ4 so that the projector PRJ4 aligns the projection image 422 with the physical coordinate 420. The length of projection image 422 is also the length L1, and the length of projection image 422 is also the length H1. According to the coordinate conversion operation of the computing circuit 430, the four corners of the projection image 422 should be aligned with the physical coordinates 412, 414, 416, and 418. However, the projection image 422 is not aligned with the physical coordinates, but there is a rotation angle RA4 between the projection image 422 and the physical coordinates.

The computing circuit 430 shoots the platform 410 and the projection image 422 projected on the platform 410 by the camera CMR4 to obtain a shooting image SC4. Through shooting image SC4, the computing circuit 430 can calculate specific value of the rotation angle RA4 and obtain a rotation calibration parameter RCP4.

In FIG. 4B, the computing circuit 430 calibrates the projection image 422 according to the rotation calibration parameter RCP4 to generate a projection image 423. The camera CMR4 projects the projection image 423 onto the platform 410. The four corners of the projection image 423 are aligned with the physical coordinates 412, 414, 416, 418. That is, in FIG. 4B, the augmented reality collaboration system 400 has completed the rotation calibration. The augmented reality collaboration system 100 of FIG. 1 may also perform the rotation calibration with reference to FIGS. 4A and 4B.

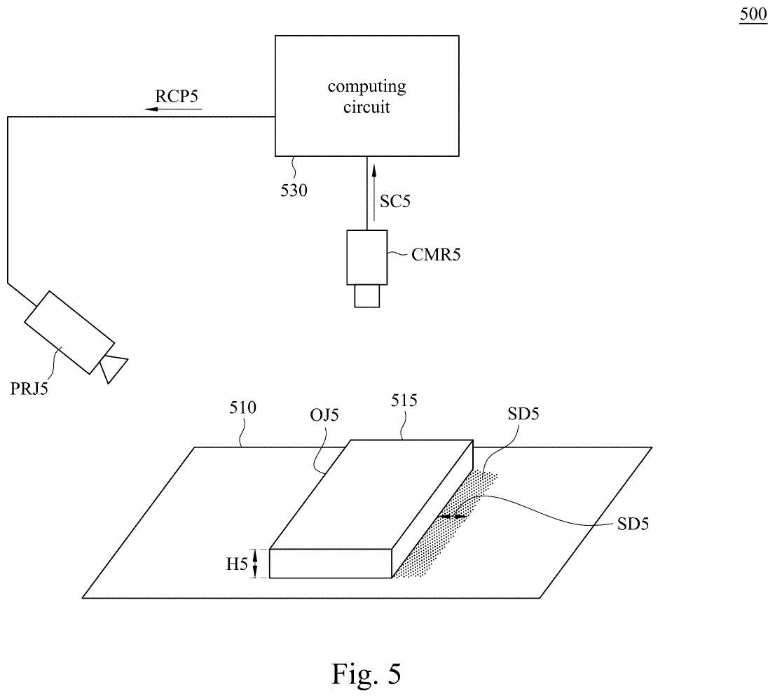

Referring to FIG. 5, FIG. 5 is a schematic diagram of a height calibration of the augmented reality collaboration system 500 according to an embodiment of the present disclosure. The augmented reality collaboration system 500 may correspond to the augmented reality collaboration system 100 of FIG. 1. The projector PRJ5 may correspond to any one of the projectors PRJ1 and PRJ2 in FIG. 1. In FIG. 5, since the projector PRJ5 is not disposed directly above a platform 510, when an object with a height is placed on the platform 510 and when the projector PRJ5 needs to project an image onto the object, the calibration parameter of projector PRJ5 needs to include the height of the object, and the calibration parameter of the projector for the platform cannot be applied directly, otherwise the projection image may be skewed.

An object OJ5 is placed on the platform 510. The object OJ5 has a height H5 and a plane 515. The computing circuit 530 controls the projector PRJ5 so that the projector PRJ5 can project image on the object OJ5 and generate a shadow area SD5 on the platform 510. The shadow area SD5 has a length SL5.

The computing circuit 530 shoots the object OJ5, the platform 510 and the shadow area SD5 created by the object OJ5 on the platform 510 by the camera CMR5 to obtain a shooting image SC5. The computing circuit 530 can analyze the shooting image SC5, and calculate specific value of the height H5 through the shadow area SD5, and obtain a height calibration parameter RCP5.

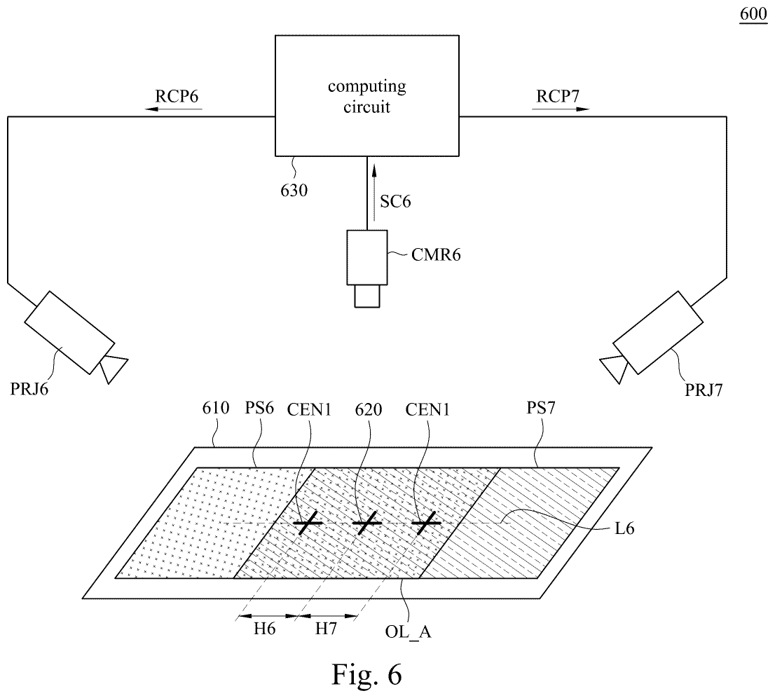

Referring to FIG. 6, FIG. 6 is a schematic diagram of a center point calibration of the augmented reality collaboration system 600 according to an embodiment of the present disclosure. The augmented reality collaboration system 600 may correspond to the augmented reality collaboration system 100 of FIG. 1. A projector PRJ6 may correspond to the projector PRJ1 in FIG. 1, and a projector PRJ7 may correspond to the projector PRJ2 in FIG. 1.

The center point of a platform 610 is a physical coordinate 620. The projector PRJ6 projects a projection image PS6 onto the platform 610, and the center point of the projection image PS6 on the platform 610 is a physical coordinate CEN1. The projector PRJ7 projects a projection image PS7 onto the platform 610, and the center point of projection image PS7 on the platform 610 is a physical coordinate CEN2. The projection image PS6 and the projection image PS7 overlap with each other to form a overlapped area OL_A.

The computing circuit 630 shoots the platform 610 and the projection images PS6 and PS7 on the platform 610 by the camera CMR6 to obtain a shooting image SC6. The computing circuit 630 can analyze the shooting image SC6 and obtain center point calibration parameters RCP6 and RCP7. The computing circuit 630 may transmit the center point calibration parameter RCP6 to the projector PRJ6 and the center point calibration parameter RCP7 to the projector PRJ7.

Through the center point calibration parameters RCP6 and RCP7, the physical coordinate CEN1 of the projection image PS6, the physical coordinate CEN2 of the projection image PS7, and the physical coordinate 620 of the platform 610 can be located on the same straight line, that is, the center line L6. Distance between the physical coordinate CEN1 and the physical coordinate 620 is a length H6, distance between the physical coordinate CEN2 and the physical coordinate 620 is a length H7, and the length H6 may be equal to the length H7.

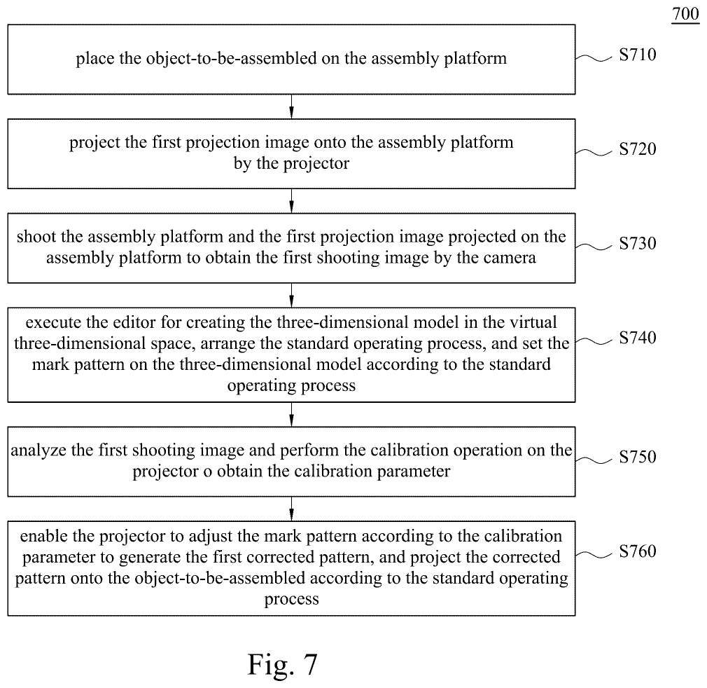

Referring to FIG. 7, FIG. 7 is a flow chart of an augmented reality collaboration method according to an embodiment of the present disclosure. The augmented reality collaboration method 700 is a method for operating the augmented reality collaboration system 100 of FIG. 1 and the augmented reality editor 200 of FIG. 2.

Step S710 is to place the object-to-be-assembled 120 on the assembly platform 110.

Step S720 is to project the first projection image onto the assembly platform 110 by the projector PRJ1.

Step S730 is to shoot the assembly platform 110 and the first projection image projected on the assembly platform 110 to obtain the first shooting image by the camera CMR1.

Step S740 is to execute the editor 135 for creating the three-dimensional model 220 in the virtual three-dimensional space 210, arrange the standard operating procedure, and set the mark pattern 225 on the three-dimensional model 220 according to the standard operating procedure.

Step S750 is to analyze the first shooting image and perform the calibration operation on the projector PRJ1 to obtain the calibration parameter RCP1.

Step S760 is to enable the projector PRJ1 to adjust the mark pattern 215 according to the calibration parameter RCP1 to generate the first corrected pattern 125, and project the corrected pattern 125 onto the object-to-be-assembled 120 according to the standard operating procedure.

In summary, the augmented reality collaboration system in the present disclosure can arrange a standard operating procedure for editing a three-dimensional model and arranging object assembly, and can also calibrate the projection image. The corrected projection image can not only display the mark pattern on the three-dimensional model at the corresponding position of the object-to-be-assembled, but also not cause distortion, skew or rotation angle offset when the corrected pattern is projected onto the object-to-be-assembled. Therefore, during the standard operating procedure of object assembly, the augmented reality collaboration system can provide clear instructions to the technicians on the production line through the calibrated projection image.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An augmented reality collaboration system, comprising:
an assembly platform, configured to place an object-to-be-assembled;
a first projector, configured to project a first projection image onto the assembly platform;
a camera, configured to shoot the assembly platform and the first projection image projected on the assembly platform to obtain a first shooting image; and
a computing circuit, coupled to the first projector and the camera, the computing circuit is configured for:
executing an editor for creating a three-dimensional model in a virtual three-dimensional space, arranging a standard operating procedure, and setting a mark pattern on the three-dimensional model according to the standard operating procedure; analyzing the first shooting image, performing a calibration operation on the first projector to obtain a first calibration parameter; and
enabling the first projector to generate a first corrected pattern according to the first calibration parameter and the mark pattern, and projecting the first corrected pattern onto the object-to-be-assembled according to the standard operating procedure.

2. The augmented reality collaboration system of claim 1, wherein a keystone calibration is performed on the first projector during the calibration operation.

3. The augmented reality collaboration system of claim 1, wherein at least one of a rotation calibration and a height calibration is performed on the first projector during the calibration operation.

4. The augmented reality collaboration system of claim 1, wherein a plurality of virtual coordinates in the virtual three-dimensional space is corresponded to a plurality of physical coordinates on the assembly platform, the three-dimensional model is corresponded to the object-to-be-assembled.

5. The augmented reality collaboration system of claim 1, wherein the camera is disposed directly above the assembly platform.

6. The augmented reality collaboration system of claim 1, further comprising:
a second projector, configured to project a second projection image onto the assembly platform,
wherein the camera shoots the assembly platform and the second projection image projected on the assembly platform to obtain a second shooting image,
wherein the computing circuit analyzes the second shooting image and performs the calibration operation on the second projector to obtain a second calibration parameter,
wherein the second projector generates a second corrected pattern according to the second calibration parameter and the mark pattern, and projects the second corrected pattern onto the object-to-be-assembled according to the standard operating procedure.

7. An augmented reality collaboration method, comprising:
placing an object-to-be-assembled on an assembly platform;
projecting a first projection image onto the assembly platform by a first projector;
shooting the assembly platform and the first projection image projected on the assembly platform to obtain a first shooting image by a camera;
executing an editor for creating a three-dimensional model in a virtual three-dimensional space, arranging a standard operating procedure, and setting a mark pattern on the three-dimensional model according to the standard operating procedure; analyzing the first shooting image, performing a calibration operation on the first projector to obtain a first calibration parameter; and
enabling the first projector to generate a first corrected pattern according to the first calibration parameter and the mark pattern, and projecting the first corrected pattern onto the object-to-be-assembled according to the standard operating procedure.

8. The augmented reality collaboration method of claim 7, wherein a keystone calibration is performed on the first projector during the calibration operation.

9. The augmented reality collaboration method of claim 7, wherein in the calibration operation, at least one of a rotation calibration and a height calibration is performed on the first projector.

10. The augmented reality collaboration method of claim 7, wherein a plurality of virtual coordinates in the virtual three-dimensional space is corresponded to a plurality of physical coordinates on the assembly platform, the three-dimensional model is corresponded to the object-to-be-assembled.

11. The augmented reality collaboration method of claim 7, wherein the camera is disposed directly above the assembly platform.

12. The augmented reality collaboration method of claim 7, further comprising:
projecting a second projection image onto the assembly platform by a second projector;
shooting the assembly platform and the second projection image projected on the assembly platform to obtain a second shooting image;
analyzing the second shooting image, performing the calibration operation on the second projector to obtain a second calibration parameter; and
generating a second corrected pattern according to the second calibration parameter and the mark pattern, and projecting the second corrected pattern onto the object-to-be-assembled according to the standard operating procedure.
